(19) United States
(12) Patent Application Publication
(10) Pub. No.: US 2015/0210596 A1
(43) Pub. Date: Jul. 30, 2015

(54) CHOPPED STRAND FOR CEMENT STRUCTURE, AND CEMENT STRUCTURE

(71) Applicant: NIPPON ELECTRIC GLASS CO., LTD., Otsu-shi (JP)

(72) Inventor: Yoshiaki OGATA, Otsu-shi (JP)

(21) Appl. No.: 14/603,454

(22) Filed: Jan. 23, 2015

(30) Foreign Application Priority Data
Jan. 28, 2014 (JP) 2014-013044
Nov. 13, 2014 (JP) 2014-230270

(51) Int. Cl. C04B 20/10

(52) U.S. Cl. CPC C04B 20/1029

(57) ABSTRACT

A chopped strand for cement structure includes a plurality of glass fiber monofilaments; and a coating layer including a glass-fiber sizing agent. The plurality of glass fiber monofilaments is coated with the coating layer. The chopped strand has an ignition loss of 0.5-3.0% by mass. The glass-fiber sizing agent includes a vinyl acetate polymer having a crosslinked structure, and a plasticizer.

### CROSS-REFERENCE TO RELATED APPLICATIONS

This application is based on and claims priority under 35 USC 119 from Japanese Patent Application Nos. 2014-013044 and 2014-230270, filed on Jan. 28, 2014 and Nov. 13, 2014, respectively, the entire contents of which is incorporated herein by reference.

### BACKGROUND

1. Technical Field

The present invention relates to a chopped strand for cement structure and to a cement structure which contains the chopped strand.

2. Related Art

Alkali-resistant glass fibers containing ZrO₂ are less apt to be corroded by alkali components contained in cements and are hence extensively used as a reinforcing material for cement structures (glass-fiber-reinforced concrete (GRC)).

A cement structure is produced by mixing mortar containing a cement, an aggregate such as sand, water, an admixture, etc. with glass fibers having a length of 5-40 mm (chopped strands for cement structure), stirring the mixture with a stirrer so that the chopped strands are uniformly dispersed, subsequently molding the mixture into a given shape, and drying the molded mixture. This method for producing a cement structure is called a premix method.

A chopped strand for cement structure is configured by bundling a plurality of glass fiber monofilaments, and a glass-fiber sizing agent is applied to the surface thereof.

The glass-fiber sizing agent has the function of bundling glass fiber monofilaments, the function of preventing the glass fiber strand or the chopped strand for cement structure from having surface scratches, and the function of inhibiting the chopped strand for cement structure from fluffing or breaking when mixed with a cement, etc. and stirred.

JP-A-11-001348 discloses a sizing agent for glass fibers which includes an acrylic ester copolymer, an ethylene-vinyl acetate copolymer, a vinyl acetate polymer, a quaternary ammonium salt, a gelatinized starch, and a silane coupling agent. It also discloses that by applying the glass-fiber sizing agent to glass fibers, the glass fiber strand can be inhibited from fluffing or breaking when drawn from the cake.

### SUMMARY OF INVENTION

A chopped strand for cement structure should be kept bundled without being opened when the chopped strand is mixed with mortar and stirred. The bundled-state retentivity of the chopped strand for cement structure considerably affects workability during stirring and the quality of the cement structure. The bundled-state retentivity of the chopped strand for cement structure greatly depends on the properties of the glass-fiber sizing agent applied.

In cases when a chopped strand for cement structure has poor bundled-state retentivity, the chopped strand for cement structure frays and becomes monofilaments to impair the flowability of the mortar. This mortar hence impairs suitability for filling into molding dies. In addition, the change of the chopped strand for cement structure into monofilaments has a problem in that the reinforcement becomes insufficient and the cement structure has reduced quality.

Since mortar contains water, one of important points in a chopped strand for cement structure is to control the bundled-state retentivity thereof, as compared with a chopped strand for FRTPs (fiber-reinforced thermoplastics) which contain little water.

Meanwhile, in cases when the amount of application of a glass-fiber sizing agent is increased in order to improve the bundled-state retentivity of a chopped strand for cement structure, the glass fiber strand, when drawn from the winding body (cake) and cut, may adhere to itself and be unable to be drawn from the cake. If this glass fiber strand is forcibly pulled out from the cake, it breaks. Thus, the workability in production of a chopped strand for cement structure decreases.

Use of the sizing agent for glass fibers disclosed in JP-A-11-001348 is effective in inhibiting the strand from fluffing or breaking when drawn from the cake. However, this strand has low bundled-state retentivity and, hence, the chopped strand undesirably becomes monofilaments immediately when mixed with mortar and stirred.

In view of the above, an illustrative aspect of the invention is to provide a chopped strand for cement structure which has good bundled-state retentivity and workability, and a cement structure which contains the chopped strand for cement structure.

The present inventor has found that by using a glass-fiber sizing agent including both a vinyl-acetate-based polymer having a crosslinked structure, and a plasticizer, the bundled-state retentivity and workability of a chopped strand for cement structure can be improved and the amount of application of the glass-fiber sizing agent can be reduced.

Namely, a chopped strand for cement structure according to an illustrative aspect of the invention includes: a plurality of glass fiber monofilaments; and a coating layer including a glass-fiber sizing agent. The plurality of glass fiber monofilaments are coated with the coating layer. The chopped strand has an ignition loss of 0.5-3.0% by mass and the glass-fiber sizing agent includes a vinyl acetate polymer having a crosslinked structure, and a plasticizer.

The glass-fiber sizing agent may include the plasticizer in an amount of 2-20 parts by mass per 100 parts by mass of the vinyl acetate polymer.

The plasticizer may be at least one of an adipic-acid-based plasticizer and a phthalic-acid-based plasticizer.

The glass fiber monofilaments may include a glass having a composition including 16-20% of ZrO₂ in terms of % by mass

A cement structure according to an illustrative aspect of the invention includes: the chopped strand for cement structure described above; and a cement.

According to the above aspects of the invention, a chopped strand for cement structure which has good bundled-state retentivity and workability can be provided, and also a cement structure which contains the chopped strand for cement structure can be provided.

### DESCRIPTION OF EMBODIMENTS

Exemplary embodiments according to the invention will be explained below. However, the invention should not be limited to the embodiments, and persons skilled in the art may suitably make modifications, improvements, etc. in the embodiments on the basis of their general knowledge within the spirit of the invention. It should be understood that such modifications and improvements are construed as within the scope of the invention.

### Glass-Fiber Sizing Agent

First, the glass-fiber sizing agent is explained. The glass-fiber sizing agent in an exemplary embodiment of the invention includes a vinyl acetate polymer having a crosslinked structure, and a plasticizer. Details thereof are explained below.

The vinyl acetate polymer is a homopolymer or copolymer of a vinyl acetate monomer. In the case where the vinyl acetate polymer is a copolymer, the copolymer is obtained by copolymerization of a vinyl acetate monomer and another monomer. Examples of the another monomer include monomers such as unsaturated chain hydrocarbons (excluding ethylene), e.g., propylene and butylene, unsaturated carboxylic acids or derivatives thereof (e.g., ester compounds), the anhydrides of unsaturated carboxylic acids or derivatives thereof, and benzene-ring-containing unsaturated hydrocarbons, e.g., styrene. In the case where the vinyl acetate polymer is a copolymer, the proportion by mass of the vinyl acetate monomer to the total mass of the ingredients for forming the vinyl acetate polymer, i.e., the vinyl acetate monomer, the other monomer(s), and a crosslinking agent which will be described later, may be preferably 70-95% by mass, more preferably 90-95% by mass, even more preferably 93-95% by mass. In the case where the vinyl acetate polymer is a copolymer, the copolymer may be any of a block copolymer, a random copolymer, and an alternating copolymer, and preferably may be a random copolymer.

The vinyl acetate polymer may be an ethylene-vinyl acetate copolymer which is a copolymer obtained by copolymerization of an ethylene monomer and a vinyl acetate monomer, or a copolymer obtained by copolymerization of an ethylene monomer, a vinyl acetate monomer, and any of the other monomers described above. In such a case, the proportion by mass of the vinyl acetate monomer to the total mass of the ingredients for forming the ethylene-vinyl acetate copolymer, i.e., the vinyl acetate monomer, the ethylene monomer, the other monomer(s), and a crosslinking agent which will be described later, may be preferably 10-75% by mass, more preferably 20-65% by mass. Meanwhile, the proportion by mass of the ethylene monomer to the total mass of the ingredients for forming the ethylene-vinyl acetate copolymer, i.e., the vinyl acetate monomer, the ethylene monomer, the other monomer(s), and a crosslinking agent which will be described later, may be preferably 10-75% by mass, more preferably 20-65% by mass. Furthermore, the proportion by mass of the sum of the vinyl acetate monomer and the ethylene monomer to the total mass of the ingredients for forming the ethylene-vinyl acetate copolymer, i.e., the vinyl acetate monomer, the ethylene monomer, the other monomer(s), and a crosslinking agent which will be described later, may be preferably 70-95% by mass, more preferably 90-95% by mass, even more preferably 93-95% by mass.

One or more monomers described above are polymerized in the presence of a crosslinking agent, and thus the vinyl acetate polymer has a crosslinked structure.

Examples of the crosslinking agent include epoxy-based crosslinking agents, glyoxal-based crosslinking agents, azetidine-based crosslinking agents, organic organosiloxane-based crosslinking agents, methylol-based crosslinking agents, and silica-based crosslinking agents. These crosslinking agents can be used either alone or in combination of two or more thereof.

When the glass-fiber sizing agent which includes a vinyl acetate polymer having a crosslinked structure is dried to form a coating layer, the coating layer has excellent strength. This sizing agent, when applied to glass fiber monofilaments, brings about good bundled-state retentivity, and the glass fiber strand is less apt to decrease in bundled-state retentivity even when an impact or shear force is given thereto.

The proportion by mass of the crosslinking agent to the total mass of the ingredients for forming the vinyl acetate polymer, i.e., the monomer(s) and the crosslinking agent, may be preferably 5-15% by mass. In case where the proportion by mass of the crosslinking agent is too small, the crosslinked structure may be insufficient. Consequently, the coating layer having sufficient strength may not be obtained, and the bundled-state retentivity may be reduced. In case where the proportion by mass of the crosslinking agent is too large, the strength of the coating layer may become too high, and the resultant glass fiber strand may be difficult to be drawn from the cake.

The content of the vinyl acetate polymer based on the total amount of the solid components contained in the glass-fiber sizing agent (the solid components being the components which remain unvaporized after the glass-fiber sizing agent is heated at 100° C. for 24 hours) may be preferably 50-95% by mass. When the content of the vinyl acetate polymer is too low, there may be a case where it is impossible to uniformly coat the whole glass fiber monofilaments. Meanwhile, when the content of the vinyl acetate polymer is too high, the coating layer with which the chopped strand for cement structure is coated may become too thick, which may result in a case where the glass fiber strand is difficult to unwind when drawn from the cake. The content of the vinyl acetate polymer is more preferably 60-80% by mass.

Examples of the plasticizer include: phthalic-acid-based plasticizers such as phthalic acid esters, e.g., di-n-octyl phthalate, di-2-ethylhexyl phthalate, dibutyl phthalate, diisononyl phthalate, butyl benzyl phthalate, dilauryl phthalate, diheptyl phthalate, dimethyl phthalate, diisodecyl phthalate, dioctyl phthalate, and dicyclohexyl phthalate; adipic-acid-based plasticizers such as adipic acid esters, e.g., dioctyl adipate, diisodecyl adipate, diisononyl adipate, and bis(2-ethylhexyl) adipate; azelaic-acid-based plasticizers such as azelaic acid esters, e.g., diisobutyl azelate, di-n-hexyl azelate, and diisooctyl azelate; benzoic-acid-based plasticizers such as benzoic acid esters, e.g., diethylene glycol dibenzoate; lauric-acid-based plasticizers such as lauric acid esters, e.g., butyl laurate and ethylene glycol monoethyl ether laurate; pentaerythritol-based plasticizers such as pentaerythritol tetraacetate; ricinoleic-acid-based plasticizers such as recinoleic acid esters, e.g., methyl acetylricinoleate; sebacic-acid-based plasticizers such as sebacic acid esters, e.g., dimethyl sebacate; citric-acid-based plasticizers such as citric acid esters, e.g., acetyl tributyl citrate; glycerin-ester-based plasticizers such as glyceryl monolauryl diacetate; sulfonic-acid-based plasticizers such as sulfonic acid esters, e.g., alkylsulfonic acid phenyl esters; and polyester-based plasticizers. These plasticizers may be used either alone or in combination of two or more thereof.

Preferred of those are adipic-acid-based and/or phthalic-acid-based plasticizers, since these plasticizers are capable of efficiently imparting flexibility to the vinyl acetate polymer.

Due to the incorporation of a plasticizer into the glass-fiber sizing agent, the plasticity of the coating layer of the glass-fiber sizing agent, which includes a vinyl acetate polymer having a crosslinked structure, can be improved and the flexibility thereof can be kept. Thus, a coating layer having high strength and flexibility can be formed.

The content of the plasticizer may be preferably 2-20 parts by mass per 100 parts by mass of the vinyl acetate polymer. When the content of the plasticizer relative to the content of the vinyl acetate polymer is too low, there may be a case where the effect of improving the flexibility of the vinyl acetate polymer is low. Meanwhile, when the content of the plasticizer relative to the content of the vinyl acetate polymer is too high, there may be a case where the vinyl acetate polymer undesirable aggregates, making it impossible to draw the glass fiber strand from the cake. The content of the plasticizer may be more preferably 3-17 parts by mass per 100 parts by mass of the vinyl acetate polymer.

The glass-fiber sizing agent in an exemplary embodiment of the invention may contain an aminosilane besides the vinyl acetate polymer and the plasticizer.

The aminosilane has alkoxy groups and an alkyl group. The alkoxy groups are hydrolyzed to become hydroxyl groups, part of which combine with the glass surface, and the remainders combine with each other to form a network structure on the glass surface. Due to this, the surface of the chopped strand for cement structure can protected against scratches and erosion.

Examples of the aminosilane include γ-aminopropyltriethoxysilane, N-β-(aminoethyl)-γ-aminopropyltrimethoxysilane, N-β-(aminoethyl)-N′-β-(aminoethyl)-γ-aminopropyltriethoxysilane, and γ-anilinopropyltrimethoxysilane. These aminosilanes can be used either alone or in combination of two or more thereof.

The glass-fiber sizing agent in an exemplary embodiment of the invention may include a silane coupling agent other than aminosilanes, such as a ureidosilane, a methacrylsilane, or an epoxysilane.

Furthermore, in addition to the ingredients described above, the glass-fiber sizing agent in an exemplary embodiment of the invention may include ingredients such as a lubricant, a nonionic surfactant, and an antistatic agent. The proportion of each ingredient may be determined according to need. As the lubricant, a fatty acid amide, a quaternary ammonium salt, or the like can be used. As the nonionic surfactant, a synthetic-alcohol-based surfactant, a natural-alcohol-based surfactant, a fatty-acid-ester-based surfactant, or the like can be used. Those ingredients may be dissolved in water or an organic solvent such as an alcohol.

### Chopped Strand for Cement Structure

Next, the chopped strand for cement structure in an exemplary embodiment of the invention is explained.

The chopped strand for cement structure in an exemplary embodiment of the invention may be produced through the following steps.

First, molten glass is drawn from the nozzles of a bushing and is cooled, thereby forming tens to thousand of glass fiber monofilaments.

Subsequently, the glass-fiber sizing agent is applied to the glass fiber monofilaments using an applicator or the like.

Then, these glass fiber monofilaments are bundled with a gathering shoe to produce a glass fiber strand.

The glass fiber strand is temporarily wound on a collet, and the glass-fiber sizing agent is dried with a dryer, thereby obtaining a winding body (cake). In this operation, a coating layer is formed. Next, the glass fiber strand is drawn from the cake and, simultaneously therewith, cut into a length of about 5-40 mm. Thus, a chopped strand for cement structure is produced.

In the chopped strand for cement structure in an exemplary embodiment of the invention, the proportion by mass of the glass-fiber sizing agent which is determined after all volatile substances have been completely volatilized, i.e., the ignition loss, is 0.5-3.0% by mass. When the ignition loss thereof is too low, the properties described above cannot be sufficiently exhibited. Meanwhile, when the ignition loss thereof is too high, the coating layer of the sizing agent becomes too thick, resulting in a decrease in workability in the production of the chopped strand for cement structure. The ignition loss thereof may be preferably 1.0-2.0% by mass.

The values of ignition loss can be measured in accordance with JIS R 3420 (2006) 7.3.2.

As glass for constituting the glass fiber monofilaments, glass having any desired composition can be used. The glass may be preferably glass having alkali resistance.

Specifically, the glass fiber monofilaments may preferably include glass which has a composition containing 16-20% of ZrO₂ in terms of % by mass. Glass having a composition containing ZrO₂ in an amount of 16% or more in terms of % by mass have good alkali resistance and, hence, the chopped strand for cement structure is less apt to be corroded by alkali components contained in cements. Meanwhile, when the glass fiber monofilaments include glass having a composition containing ZrO₂ in an amount of 20% or less in terms of % by mass, the chopped strand for cement structure can be produced therefrom at a relatively low cost. The glass fiber monofilaments may more preferably include glass which has a composition containing 17-19% of ZrO₂ in terms of % by mass.

Examples of the glass having alkali resistance include glass having a composition which contains, in terms of % by mass, 54-65% of SiO₂, 16-20% of ZrO₂, 0-5% of Li₂O, 10-17% of Na₂O, 0.5-8% of K₂O, 0-10% of RO (wherein R represents Mg, Ca, Sr, Ba, and Zn), 0.5-7% of TiO₂, and 0-2% of Al₂O₃.

When the glass fiber monofilaments have an average fiber diameter of 9-27 μm, the mixture of mortar and the chopped strand for cement structure can develop excellent flowability in molding a cement structure, resulting in an improvement in workability.

The average diameter of glass fiber monofilaments may be determined through a measurement with an optical microscope, or may be determined through a measurement with a laser measuring instrument or the like.

Furthermore, when the chopped strand for cement structure in an exemplary embodiment of the invention is produced by cutting the glass fiber strand which has a count of 30-200 tex, the mixture of mortar and the chopped strand for cement structure can develop excellent flowability when used for molding a cement structure, resulting in an improvement in workability. When the glass fiber strand has too small a count, the surface area of the chopped strand for cement structure may become too large and there may be a case where the flowability of the mixture of mortar and the chopped strand for cement structure, when used for molding a cement structure, is reduced. Meanwhile, when the glass fiber strand has too large a count, the surface area of the chopped strand for cement structure may be reduced and an area of adhesion to mortar may also be reduced and then there may be a case where the strength of the cement structure is reduced.

### Cement Structure

The cement structure in an exemplary embodiment of the invention includes the chopped strand for cement structure described above and a cement.

The cement structure may be produced by mixing the chopped strand for cement structure which has a length of 5-40 mm with mortar including a cement, an aggregate such as sand, water, an admixture, etc., stirring the resultant mixture, subsequently molding the mixture into a given shape, and drying the molded mixture.

The content of the chopped strand for cement structure in the cement structure may be preferably 0.1-5% by mass. When the content of the chopped strand for cement structure is too low, the content of the chopped strand for cement structure may be insufficient and there may be a case where the reinforcing effect is not sufficient. Meanwhile, when the content of the chopped strand for cement structure is too high, the flowability of the mortar may be insufficient and may deteriorate in suitability for filling into molding dies or for degassing, and thus there may be a case where the strength of a cement structure is reduced. The content of the chopped strand for cement structure may be more preferably 1-4% by mass,

### EXAMPLES

Exemplary embodiments of the invention will be explained below in detail by reference to Examples, but the invention should not be limited to the Examples.

Methods for producing the test specimens according to Examples and Comparative Examples are explained below.

### Examples

As specimen No. 1, a chopped strand for cement structure was produced in the following manner.

First, molten glass having a composition including 61.0% of SiO₂, 19.5% of ZrO₂, 1.5% of Li₂O, 12.3% of Na₂O, 2.6% of K₂O, 0.5% of CaO, and 2.6% of TiO₂ in terms of % by mass was drawn from a plurality of nozzles formed in a bushing to produce glass fiber monofilaments having an average diameter of 16 μm. The glass-fiber sizing agent which is described later was applied to the glass fiber monofilaments with an applicator such that the eventually-obtained chopped strand has an ignition loss of 1.8% by mass, and seventy of the glass fiber monofilaments were bundled into one, thereby obtaining a glass fiber strand having a count of 40 tex. This glass fiber strand was wound on a collet to thereby obtain a cake.

The glass-fiber sizing agent applied to the glass fiber strand was dried at a temperature of 130° C. for 10 hours. Thereafter, the glass fiber strand was drawn from the cake and, simultaneously therewith, cut into a length of 13 mm. Thus, a chopped strand for cement structure was obtained.

The glass-fiber sizing agent was produced by preparing with deionized water so as to contain 12% by mass of vinyl acetate resin having a crosslinked structure (CC908, manufactured by Henkel Japan Ltd.), 0.8% by mass of dibutyl phthalate (manufactured by Showa Ether Co., Ltd.), 0.3% by mass of aminosilane (KBE903, manufactured by Shin-Etsu Chemical Co., Ltd.), and 0.3% by mass of paraffin wax (Smoother SW40, manufactured by Yoshimura Oil Chemical Co., Ltd.). Incidentally, the proportion by mass of the plasticizer (B) to the vinyl acetate resin (A) having a crosslinked structure, the amount of the resin (A) being taken as 100, i.e., the value of B/Ax 100, was as shown in Table 1.

Specimen No. 2 was produced in the same manner as for specimen No. 1, except that a glass-fiber sizing agent was prepared so as to contain 6% by mass of the vinyl acetate resin having a crosslinked structure, 6% by mass of ethylene-vinyl acetate copolymer resin not having a crosslinked structure (Mowinyl 186E, manufactured by The Nippon Synthetic Chemical Industry Co., Ltd.), 0.4% by mass of the dibutyl phthalate, 0.3% by mass of the aminosilane, and 0.2% by mass of the paraffin wax.

Specimen No. 3 was produced in the same manner as for specimen No. 1, except that a glass-fiber sizing agent was prepared so as to contain 6% by mass of the vinyl acetate resin having a crosslinked structure, 6% by of mass ethylene-vinyl acetate copolymer resin not having a crosslinked structure (Mowinyl 186E, manufactured by The Nippon Synthetic Chemical Industry Co., Ltd.), 1.0% by mass of the dibutyl phthalate, 0.7% by mass of the aminosilane, and 0.7% by mass of the paraffin wax.

Specimen No. 4 was produced in the following manner. Molten glass having the same composition as for specimen No. 1 was drawn from a plurality of nozzles formed in a bushing to produce glass fiber monofilaments having an average diameter of 18 μm. The glass-fiber sizing agent which is described later was applied to the glass fiber monofilaments with an applicator such that the eventually-obtained chopped strand has an ignition loss of 1.2% by mass, and two hundreds of the glass fiber monofilaments were bundled into one, thereby obtaining a glass fiber strand having a count of 140 tex. This glass fiber strand was wound on a collet to thereby obtain a cake.

The glass-fiber sizing agent applied to the glass fiber strand was dried at a temperature of 130° C. for 10 hours. Thereafter, the glass fiber strand was drawn from the cake and, simultaneously therewith, cut into a length of 13 mm. Thus, chopped strands for cement structure were obtained.

The glass-fiber sizing agent was produced by preparing with deionized water so as to contain 8% by mass of vinyl acetate resin having a crosslinked structure (CC908, manufactured by Henkel Japan Ltd.), 4% by mass of ethylene-vinyl acetate copolymer resin not having a crosslinked structure (Mowinyl 186E, manufactured by The Nippon Synthetic Chemical Industry Co., Ltd.), 0.6% by mass of diisodecyl adipate (manufactured by New Japan Chemical Co., Ltd.), 0.4% by mass of aminosilane (KBE903, manufactured by Shin-Etsu Chemical Co., Ltd.), and 0.3% by mass of paraffin wax (Smoother SW40, manufactured by Yoshimura Oil Chemical Co., Ltd.).

Specimen No. 5 was produced in the same manner as for specimen No. 4, except that a glass-fiber sizing agent was prepared so as to contain 6% by mass of the vinyl acetate resin having a crosslinked structure, 6% by mass of the ethylene-vinyl acetate copolymer resin not having a crosslinked structure, 0.4% by mass of the diisodecyl adipate, 0.3% by of mass the aminosilane, and 0.4% by mass the paraffin wax.

### Comparative Examples

Specimen No. 6 was produced in the same manner as for specimen No. 1, except that a glass-fiber sizing agent was prepared so as to contain 12% by mass of the vinyl acetate resin having a crosslinked structure, 0.3% by of mass the aminosilane, and 0.3% by mass of the paraffin wax.

Specimen No. 7 was produced in the same manner as for specimen No, 1, except that a glass-fiber sizing agent was prepared so as to contain 6% by mass of vinyl acetate resin not having a crosslinked structure (Yodosol VC53, manufactured by Henkel Japan Ltd.), 6% by mass of ethylene-vinyl acetate copolymer resin not having a crosslinked structure (Mowinyl 186E, manufactured by The Nippon Synthetic Chemical Industry Co., Ltd.), 0.3% by mass of the aminosilane, and 0.2% by mass of the paraffin wax.

Specimen No. 8 was produced in the same manner as for specimen No. 4, except that a glass-fiber sizing agent was prepared so as to contain 6% by mass of the vinyl acetate resin having a crosslinked structure, 6% by mass of the ethylene-vinyl acetate copolymer resin not having a crosslinked structure, 0.7% by mass of the aminosilane, and 0.7% by mass the paraffin wax.

Specimen No. 9 was produced in the same manner as for specimen No. 4, except that a glass-fiber sizing agent was prepared so as to contain 8% by mass of vinyl acetate resin not having a crosslinked structure (Yodosol VC53, manufactured by Henkel Japan Ltd.), 4% by mass of the ethylene-vinyl acetate copolymer resin not having a crosslinked structure, 0.4% by mass of the aminosilane, and 0.3% by mass of the paraffin wax.

Specimen No. 10 was produced in the following manner. Molten glass having the same composition as for specimen No. 1 was drawn from a plurality of nozzles formed in a bushing to produce glass fiber monofilaments having an average diameter of 16 μm. The glass-fiber sizing agent which is described later was applied to the glass fiber monofilaments with an applicator such that the eventually-obtained chopped strand has an ignition loss of 3.5% by mass, and seventy of the glass fiber monofilaments were bundled into one, thereby obtaining a glass fiber strand having a count of 40 tex. This glass fiber strand was wound on a collet to thereby obtain a cake.

The glass-fiber sizing agent was produced by preparing with deionized water so as to contain 12% by mass of vinyl acetate resin having a crosslinked structure (CC908, manufactured by Henkel Japan Ltd.), 0.8% by of mass dibutyl phthalate (manufactured by Showa Ether Co., Ltd.), 0.3% by mass of aminosilane (KBE903, manufactured by Shin-Etsu Chemical Co., Ltd.), and 0.2% by mass of paraffin wax (Smoother SW40, manufactured by Yoshimura Oil Chemical Co., Ltd.).

The glass-fiber sizing agentapplied to the glass fiber strand was dried at a temperature of 130° C. for 10 hours. Thereafter, it was attempted to draw the glass fiber strand from the cake. However, the glass fiber strand was tenaciously adherent to itself and, hence, a chopped strand for cement structure was unable to be produced.

### Evaluation

Workability was evaluated as to whether the glass fiber strand was able to be drawn from the cake when the drawing was attempted. The case where the glass fiber strand was able to be drawn from the cake and be cut is indicated by “good”, and the case where the glass fiber strand was unable to be drawn from the cake and be cut is indicated by “poor”.

Each of the chopped strands for cement structure produced above was used to examine bundled-state retentivity.

The bundled-state retentivity in mortar of the chopped strands for cement structure was evaluated by adding 3 g of the chopped strand for cement structure to mortar containing 250 g of a cement, 250 g of silica sand, and 110 g of water, stirring the mixture for 5 minutes using a stirrer at 600 rpm, and then visually examining the bundled state of the chopped strand for cement structure. Specifically, the chopped strand for cement structure were taken out as much as possible from the mortar, and the chopped strand taken out was visually divided into opened chopped strand for cement structure and unopened chopped strand for cement structure. The opened chopped strand and the unopened chopped strand were weighed, and the value of (weight of the chopped strand opened into monofilaments)/(total weight (3 g)) was taken as the degree of opening of the chopped strand for cement structure. The case where the degree of opening was 0-40% is indicated by “1”, the case where the degree of opening was higher than 40% but less than 70% is indicated by “2”, and the case where the degree of opening was 70% or higher is indicated by “3”. In this evaluation, the rating “1” shows that the chopped strand was in an appropriately opened state, which means that the bundled-state retentivity is good.

Meanwhile, the bundled-state retentivity of the chopped strand for cement structure which was in a dry state was evaluated in the following manner. Five kilograms of silica sand were stirred together with 50 g of the chopped strand for cement structure using a stirrer at 300 rpm for 5 minutes, and the chopped strands for cement structure only were then collected using a sieve. The bundled-state retentivity of the chopped strand for cement structure was evaluated in terms of the proportion of the bulk density b (g/cm³) of the chopped strand for cement structure as measured before introduction into the stirrer to the bulk density a (g/cm³) of the collected chopped strand for cement structure, i.e., the proportion b/a. The larger the value of b/a, the poorer the bundled-state retentivity; and the closer to 1 the value of b/a, the better the bundled-state retentivity.

The results of evaluation obtained in the Examples and Comparative Examples are shown in Tables 1 and 2.

TABLE 1

| | | Example | | | | |
|---|---|---|---|---|---|---|
| Specimen No. | | 1 | 2 | 3 | 4 | 5 |
| Vinyl-acetate- | Vinyl acetate resin | 12 | 6 | 6 | 8 | 6 |
| based | (crosslinked | | | | | |
| polymer (A) | structure) (mass %) | | | | | |
| Plasticizer (B) | Dibutyl phthalate | 0.8 | 0.4 | 1.0 | 0 | 0 |
| | (mass %) | | | | | |
| | Diisodecyl adipate | 0 | 0 | 0 | 0.6 | 0.4 |
| | (mass %) | | | | | |

| | | | | | |
|---|---|---|---|---|---|
| (B)/(A) × 100 | 6.7 | 6.7 | 16.7 | 7.5 | 6.7 |
| Aminosilane (mass %) | 0.3 | 0.3 | 0.7 | 0.4 | 0.3 |
| Paraffin wax (mass %) | 0.3 | 0.2 | 0.7 | 0.3 | 0.4 |
| Ethylene/vinyl acetate copolymer | 0 | 6 | 6 | 4 | 6 |
| resin (uncrosslinked structure) | | | | | |
| (mass %) | | | | | |
| Fiber diameter (μm) | 16 | 16 | 16 | 18 | 18 |
| Count (tex) | 40 | 40 | 40 | 140 | 140 |
| Ignition loss (mass %) | 1.8 | 1.8 | 1.8 | 1.2 | 1.2 |
| Workability | good | good | good | good | good |
| Bundled-state retentivity in mortar | 1 | 1 | 1 | 1 | 1 |
| (rating) | | | | | |
| Bundled-state retentivity in dry state | 1.05 | 1.10 | 1.05 | 1.00 | 1.05 |

TABLE 2

| | | Comparative Example | | | | |
|---|---|---|---|---|---|---|
| Specimen No. | | 6 | 7 | 8 | 9 | 10 |
| Vinyl-acetate- | Vinyl acetate resin | 12 | 0 | 6 | 0 | 12 |
| based | (crosslinked | | | | | |
| polymer (A) | structure) (mass %) | | | | | |
| Plasti-cizer (B) | Dibutyl phthalate | 0 | 0 | 0 | 0 | 0.8 |
| | (mass %) | | | | | |
| | Diisodecyl adipate | 0 | 0 | 0 | 0 | 0 |
| | (mass %) | | | | | |
| (B)/(A) × 100 | | 0.0 | — | 0.0 | — | 6.7 |
| Vinyl- | Vinyl acetate resin | 0 | 6 | 0 | 8 | 0 |
| acetate- | (uncrosslinked | | | | | |
| based | structure) (mass %) | | | | | |
| polymer | Ethylene-vinyl acetate | 0 | 6 | 6 | 4 | 0 |
| | copolymer resin | | | | | |
| | (uncrosslinked | | | | | |
| | structure) (mass %) | | | | | |

| | | | | | |
|---|---|---|---|---|---|
| Aminosilane (mass %) | 0.3 | 0.3 | 0.7 | 0.4 | 0.3 |
| Paraffin wax (mass %) | 0.3 | 0.2 | 0.7 | 0.3 | 0.2 |
| Fiber diameter (μm) | 16 | 16 | 18 | 18 | 16 |
| Count (tex) | 40 | 40 | 140 | 140 | 40 |
| Ignition loss (mass %) | 1.8 | 1.8 | 1.2 | 1.2 | 3.5 |
| Workability | good | good | good | good | poor |
| Bundled-state retentivity in mortar | 3 | 2 | 2 | 2 | — |
| (rating) | | | | | |
| Bundled-state retentivity in dry state | 1.35 | 1.35 | 1.30 | 1.33 | — |

What is claimed is:

1. A chopped strand for cement structure, comprising:
a plurality of glass fiber monofilaments; and
a coating layer including a glass-fiber sizing agent, the plurality of glass fiber monofilaments being coated with the coating layer,
wherein
the chopped strand has an ignition loss of 0.5-3.0% by mass, and
the glass-fiber sizing agent includes a vinyl acetate polymer having a crosslinked structure, and a plasticizer.

2. The chopped strand according to claim 1, wherein the glass-fiber sizing agent includes the plasticizer in an amount of 2-20 parts by mass per 100 parts by mass of the vinyl acetate polymer.

3. The chopped strand according to claim 1, wherein the plasticizer is at least one of an adipic-acid-based plasticizer and a phthalic-acid-based plasticizer.

4. The chopped strand according to claim 1, wherein that the glass fiber monofilaments include a glass having a composition including 16-20% of ZrO₂ in terms of % by mass.

5. A cement structure comprising: a chopped strand according to claim 1; and a cement.

6. A cement structure comprising: a chopped strand according to claim 2; and a cement.

7. A cement structure comprising: a chopped strand according to claim 3; and a cement.

8. A cement structure comprising: a chopped strand according to claim 4; and a cement.
